(19) United States
(12) Patent Application Publication
(10) Pub. No.: US 2016/0365613 A1
(43) Pub. Date: Dec. 15, 2016

(54) BATTERY AND SUPERCAPACITOR HYBRID

(71) Applicant: American Lithium Energy Corporation, Vista, CA (US)

(72) Inventor: Jiang Fan, San Diego, CA (US)

(21) Appl. No.: 15/177,236

(22) Filed: Jun. 8, 2016

Related U.S. Application Data
(60) Provisional application No. 62/173,155, filed on Jun. 9, 2015.

(51) Int. Cl. H01M 12/00; H01M 4/131; H01M 2/34; H01M 10/42; H01G 11/32; H01G 11/60; H01G 11/52; H01G 11/14; H01G 11/26; H01G 11/50; H01G 11/68; H01G 11/56; H01M 10/0525; H01G 11/70

(52) U.S. Cl. CPC H01M 12/005; H01M 10/0525; H01M 4/131; H01M 2/345; H01M 10/4235; H01G 11/32; H01G 11/70; H01G 11/52; H01G 11/14; H01G 11/26; H01G 11/50; H01G 11/68; H01G 11/56; H01G 11/60; H01M 2200/20; H01M 2220/20

(57) ABSTRACT

A battery and supercapacitor hybrid can include a first hybrid electrode. The first hybrid electrode can include a first electrode, a first current collector, and a first supercapacitor. The battery and supercapacitor hybrid can further include a second hybrid electrode and a separator interposed between the first hybrid electrode and the second hybrid electrode.

### RELATED APPLICATION

This application claims priority under 35 U.S.C. §119(e) to U.S. Provisional Patent Application No. 62/173,155, entitled NOVEL LI-ION BATTERY/SUPER CAPACITOR HYBRID and filed on Jun. 9, 2015, the disclosure of which is incorporated herein by reference in its entirety.

### TECHNICAL FIELD

The subject matter described herein relates generally to energy storage and, more specifically, to batteries.

### RELATED ART

Battery performance can be assessed in terms of both energy density and power density. The energy density of a battery is a measure of the amount of energy that the battery is capable of storing (e.g., per unit of the battery's volume or mass). A high energy battery is able to store a large amount of energy (e.g., relative to the battery's volume or mass) and is more desirable for applications that require longer run times (e.g., rechargeable or secondary batteries). Meanwhile, the power density of a battery indicates how fast a battery is able to accept and/or deliver energy (e.g., rate of energy transfer). Accordingly, a battery with high power density tends to charge and discharge quickly. Such a battery may be desirable in applications that produce and/or consume rapid bursts of energy (e.g., vehicular acceleration).

An optimal battery should be both high energy and high power. But despite having high energy density, conventional batteries (e.g., lithium (Li) ion) tend to have poor power density. This is because electrodes in conventional batteries often include material (e.g., graphitized carbon for lithium ion batteries) that limits charging speed. Moreover, conventional batteries are susceptible to fire and explosion when exposed to a high charging current. As such, conventional batteries alone are not desirable for a number of significant applications. For instance, the high charging current from a regenerative braking system (e.g., in an electric vehicle) is likely to damage a conventional battery, which shortens the battery's lifespan as well as raises safety concerns.

### SUMMARY

Articles of manufacture, including batteries, are provided. Implementations of the current subject matter improve the power density of lithium ion batteries including by providing a hybrid that integrates a battery and a supercapacitor. For example, the battery and supercapacitor hybrid is able to charge and discharge at a higher rate than a battery alone. Moreover, the battery and supercapacitor hybrid is able to tolerate a higher charging current than a battery alone. A high charging current does not degrade the lifespan of the battery and supercapacitor hybrid nor would exposing the hybrid to a high charging current raise any safety concern. Furthermore, the battery and supercapacitor hybrid consistent with implementations of the current subject matter is able to operate without requiring an electronic management system to coordinate the performance of battery and supercapacitor. By contrast, a conventional combination of an independent battery and supercapacitor requires an electronic management system to optimize battery life and safety. Obviating an electronic management system can decrease the cost of battery and super capacitor hybrid system significantly.

Implementations of the current subject matter include a battery and supercapacitor hybrid. The battery and supercapacitor hybrid can include a first hybrid electrode that includes a first battery electrode, a first current collector, and a first supercapacitor electrode. The battery and supercapacitor hybrid can further include a second hybrid electrode and a separator. The separator can be interposed between the first hybrid electrode and the second hybrid electrode.

Implementations of the current subject matter further enhance battery design customization including by separating the material for the electrode (e.g., anode and/or cathode) of the battery from the material for the electrode of the supercapacitor in the battery and supercapacitor hybrid. As such, the performance of the battery and the performance of the supercapacitor can be optimized independently. By contrast, blending these two materials requires optimization to be performed collectively as a whole. Independent optimization of the performance of battery and supercapacitor can be desirable because the requirement for the battery may differ from that of the supercapacitor.

Implementations of the current subject matter further decreases manufacturing cost including by providing a hybrid where the battery's electrode (e.g., anode and/or cathode) is in contact with the supercapacitor, thereby allowing the battery's electrode to act as the lithium source for the negative electrode of a lithium-ion supercapacitor. This configuration eliminates the need of the sacrificial lithium metal as the initial lithium source for the lithium ion supercapacitor. The negative electrode of a lithium ion supercapacitor can include disorder carbon while the positive electrode of the lithium ion supercapacitor can include active carbon. Sacrificial lithium metal can be introduced during a conventional manufacturing process in order to add lithium to the negative electrode of the supercapacitor and maximize the energy density of lithium ion supercapacitor. Implementations of the current subject matter obviate the inclusion of sacrificial lithium metal, which can decrease the manufacturing cost of lithium ion supercapacitor significantly.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to radiation therapy, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a schematic of a hybrid electrode consistent with implementations of the current subject matter;

FIG. 1B depicts a schematic of a hybrid electrode consistent with implementations of the current subject matter

FIG. 2 depicts a schematic of a hybrid electrode consistent with implementations of the current subject matter;

FIG. 3 depicts a schematic of a hybrid electrode consistent with implementations of the current subject matter;

FIG. 4A depicts a schematic of a hybrid electrode consistent with implementations of the current subject matter;

FIG. 4B depicts a schematic of a hybrid electrode consistent with implementations of the current subject matter;

FIG. 5A depicts a three dimensional current collector consistent with implementations of the current subject matter;

FIG. 5B depicts a three dimensional current collector consistent with implementations of the current subject matter;

FIG. 6 depicts a schematic of a hybrid electrode consistent with implementations of the current subject matter;

FIG. 7 depicts a schematic of a battery and supercapacitor hybrid consistent with implementations of the current subject matter;

FIG. 8 depicts a graph illustrating the relationship between battery capacity and battery voltage at different charging and discharging currents; and

FIG. 9 depicts a graph illustrating the voltage profile and temperature profile of a battery as the battery is overcharged over a period of time.

### DETAILED DESCRIPTION

As noted above, conventional batteries can have limited power density. For example, the anode of a lithium ion battery is typically constructed from graphitized carbon. During the discharge of a lithium ion battery, lithium ions are extracted (e.g., deintercalated) from the graphitized carbon at the anode of the battery. By contrast, lithium ions are inserted (e.g., intercalated) back into the graphitized carbon when the lithium ion battery is being charged. This insertion of lithium ions back into the graphitized carbon tends to be slow, which limits the rate at which a conventional lithium ion battery is able to accept energy. In addition, the rate at which a conventional lithium ion battery delivers power can also be slow, particularly as the battery approaches a fully discharged state. Furthermore, conventional batteries cannot safely tolerate a high charging current. For instance, a high charging current can lead to hazardous overcharging of a lithium ion battery. The graphitized carbon in an overcharged lithium ion battery can be packed with metal lithium, which renders the battery unstable and fire prone. Thus, conventional lithium ion batteries are not desirable for applications that produce and/or consume rapid bursts of energy.

Various implementations of the current subject matter can include articles of manufacture for a battery and supercapacitor hybrid. The battery may be a lithium ion battery (e.g., having a lithium metal oxide cathode). Combining the lithium ion battery with a supercapacitor can improve the power density of the lithium ion battery because the supercapacitor can be adapted to provide high energy at a high rate (e.g., fast charge and/or discharge of a large amount of energy). For instance, the supercapacitor can provide bursts of energy as well as tolerate high charging currents. At the same time, the battery and supercapacitor hybrid can also provide high energy density. For example, the lithium ion battery can provide a high capacity for storing energy. As such, the battery and supercapacitor hybrid can be desirable for a wide range of applications including applications that require both long run times, frequent energy bursts, and a tolerance for high charging currents.

In some implementations of the current subject matter, the battery and supercapacitor hybrid can include separate electrodes (e.g., anode and/or cathode) of battery and supercapacitor. That is, the material for the electrode and the supercapacitor are not blended. Separating the battery electrode from the supercapacitor electrode allows the performance of the battery and the performance of the supercapacitor to be optimized independently.

In some implementations of the current subject matter, the battery and supercapacitor hybrid can include a porous current collector. For example, the battery and supercapacitor hybrid can include a sheet (e.g., foil) current collector or a three dimensional current collector (e.g., foam, net) formed from a porous material. The porous current collector can be interposed between the supercapacitor electrode and the battery electrode (e.g., anode and/or cathode) in the battery and supercapacitor hybrid. The porosity of the current collector can allow a diffusion of lithium ions from the battery electrode to the supercapacitor electrode. The addition of lithium ions to the supercapacitor electrode can increase the capacitance of the supercapacitor and further enhance the power density of the battery and supercapacitor hybrid. Moreover, the battery electrode can act as a source of lithium ions for the supercapacitor electrode (e.g., the negative electrode of a lithium ion supercapacitor). This obviates the inclusion of sacrificial lithium metal thereby simplifying the manufacturing processes of the lithium ion supercapacitor as well as reducing the cost the cost of the lithium ion supercapacitor.

In some implementations of the current subject matter, the battery and supercapacitor hybrid can include at least one safety layer. The safety layer can be interposed between the electrode (e.g., anode and/or cathode) and the current collector. For example, the safety layer can include thermosensitive or voltage-sensitive or current-sensitive or the combination of all materials that exhibit higher electrical resistance as the temperature increases (e.g., positive temperature coefficient of electrical resistance) or voltage increase or current increase or the combination of all. Alternately or additionally, the safety layer can be a thermosensitive or voltage-sensitive or current-sensitive or the combination of all material that is adapted to generate and release a gas as the temperature increases and/or reaches a threshold. The release of the gas can form a nonconductive gap that electrically decouples the electrode from the current collector.

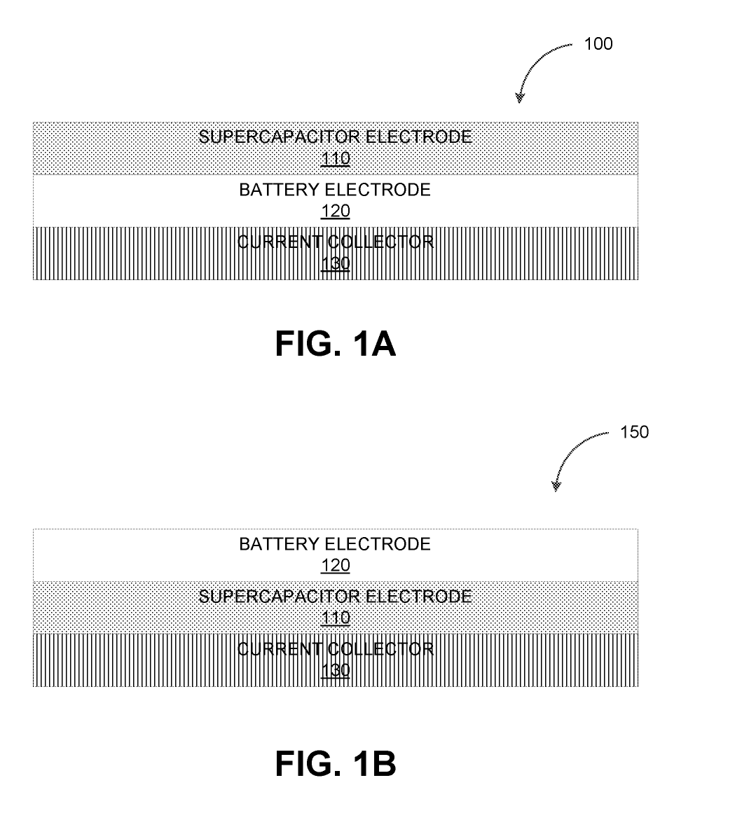

FIG. 1A depicts a schematic of a hybrid electrode 100 consistent with implementations of the current subject matter. Referring to FIG. 1A, the hybrid electrode 100 can include a supercapacitor electrode 110, a battery electrode 120 (e.g., anode and/or cathode), and a current collector 130. As shown in FIG. 1A, the supercapacitor electrode 110 can be disposed (e.g., coated) directly on top of the battery electrode 120 while the battery electrode 120 is disposed (e.g., coated) on top of the current collector 130. The current collector 130 can be a sheet (e.g., foil) or a three dimensional structure (e.g., foam, net) formed from one or more conductive materials including, for example, aluminum (Al), copper (Cu), nickel (Ni), titanium (Ti), carbon (e.g., graphene), and/or stainless steel.

FIG. 1B depicts a schematic of a hybrid electrode 150 consistent with implementations of the current subject matter. Referring to FIGS. 1A-B, the hybrid electrode 150 can include the supercapacitor electrode 110, the battery electrode 120, and the current collector 130. The supercapacitor electrode 110, the battery electrode 120, and the current collector 130 can be arranged in a different configuration than shown in FIG. 1A. As shown in FIG. 1B, the battery electrode 120 can be disposed (e.g., coated) directly on top of the supercapacitor electrode 110 while the supercapacitor electrode 110 is disposed (e.g., coated) on top of the current collector 130.

In some implementations of the current subject matter, the hybrid electrode 100 can be configured to act as the cathode of a battery and supercapacitor hybrid. As such, the electrode 120 can include (e.g., be coated with) a lithium metal oxide such as, for example, doped lithium nickel cobalt magnesium (NCM) oxide (LiNi_{1-x-y}CoₓMn_{y}O₂), doped lithium nickel oxides, or lithium iron phosphates. The supercapacitor electrode 110 can include a mixture of activated carbon (e.g., YP-50F) and/or graphene (e.g., xGnP-R-10) with one or more other additives.

Alternately, the battery electrode 120 and supercapacitor electrode 110 can be configured to act as the anode of a battery and supercapacitor hybrid. Accordingly, the battery electrode 120 and supercapacitor electrode 110 can include a single layer or multiple-layers. For example, the battery electrode 120 and the supercapacitor electrode 110 can be a single layer of highly porous disordered carbon or lithium titanate or contain an appropriate type of petroleum coke. Alternately, the battery electrode 120 can be a high energy graphitized carbon while the supercapacitor electrode 110 can be a highly porous disordered carbon, an active carbon, graphene, and/or titanium oxide.

In some implementations of the current subject matter, the layers of the hybrid electrode 100 (e.g., the supercapacitor electrode 110, the battery electrode 120, and the current collector 130) can be manufactured using a conventional slot die with a multiple layer coating capability. For example, the materials forming the supercapacitor electrode 110 and the battery electrode 120 can be simultaneously applied onto the current collector 130 by using a slot die with two slurry outputs.

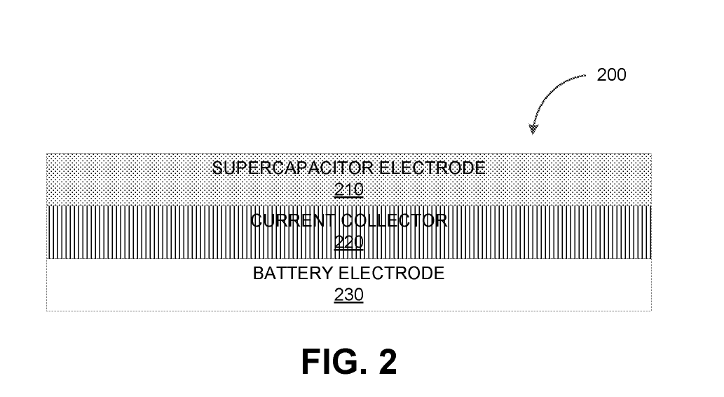

FIG. 2 depicts a schematic of a hybrid electrode 200 consistent with implementations of the current subject matter. Referring to FIG. 2, the hybrid electrode 200 can include a supercapacitor electrode 210, a current collector 220, and a battery electrode 230. As shown in FIG. 2, the current collector 220 can be interposed between the supercapacitor electrode 210 and the battery electrode 230. That is, the supercapacitor electrode 210 can be disposed on one side of the current collector 220 while the battery electrode 230 is disposed on the other side of the current collector 220. In some implementations of the current subject matter, the current collector 220 can be formed from a porous material that allows the diffusion of lithium ions from the electrode 230 to the supercapacitor electrode 210.

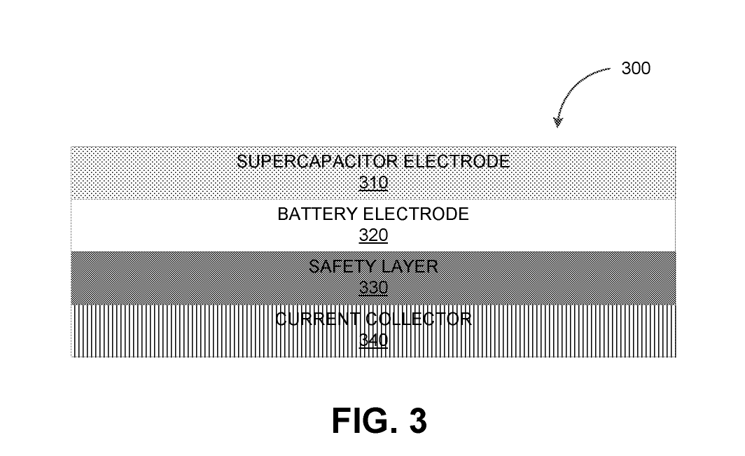

FIG. 3 depicts a schematic of a hybrid electrode 300 consistent with implementations of the current subject matter. Referring to FIG. 3, the hybrid electrode 300 can include a supercapacitor electrode 310, a battery electrode 320, a safety layer 330, and a current collector 340.

The safety layer 330 can include one or more thermal, voltage, and/or current sensitive materials that exhibit higher electrical resistance when exposed to a higher temperature, voltage, and/or current. Alternately or additionally, the safety layer 330 can include one or more temperature, voltage, and/or current sensitive materials that are adapted to generate and release a gas as the temperature, voltage, and/or current increases and/or reaches a threshold. For instance, in some implementations of the current subject matter, the safety layer 330 can be formed from a combination of carbonate salts (e.g., Ca₂CO₃, Li₂CO₃, CuCO₃), sulfate, or nitrate, or sodium trisilicate (NaSiO₃), and conductive additives (e.g., carbon black, carbon (C) nanostructures (e.g., tubes, wires, fibers), and graphene).

In some implementations of the current subject matter, the safety layer 330 can include one or more materials that decompose at high temperatures, voltages, and/or currents to form a gas or electrically non-conductive liquid. A failure within a battery containing the hybrid electrode 300 can be accompanied by an increase in temperature, which can exceed the ability of the battery to dissipate heat and lead to hazardous conditions (e.g., fire, explosion). For example, temperature can increase when the battery experiences a separator short circuit, electrode overcharge, and/or electrode overheating. The increase in temperature can trigger a decomposition of the safety layer 330. The decomposition of the safety layer 330 can release a gas that causes a delamination of the electrode 320 from the current collector 340. The separation of the electrode 320 from the current collector 340 can form a nonconductive gap that interrupts the electrical coupling between the electrode 320 and the current collector 340. This interruption can prevent a continued rise in the temperature of the battery containing the hybrid electrode 300, thereby avoiding hazards such as fires and/or explosions.

In some implementations of the current subject matter, the hybrid electrode 300 can be configured to act as the cathode of a battery and supercapacitor hybrid. As such, the battery electrode 320 can include (e.g., be coated with) a lithium metal oxide such as, for example, doped lithium nickel cobalt magnesium (NCM) oxide (LiNi_{1-x-y}CoₓMn_{y}O₂). The supercapacitor electrode 310 can include a mixture of activated carbon and/or graphene or oxides with one or more other additives.

Alternately, the battery electrode 320 can be configured to act as the anode or negative electrode of a battery and supercapacitor hybrid. Accordingly, the battery electrode 320 and supercapacitor electrode 310 can be one or more layers. For example, the battery electrode 320 and supercapacitor electrode 310 can be a single layer of lithium titanate or a highly porous disordered carbon that is suitable for both battery and supercapacitor. Alternately, the electrode 320 can be one layer of high energy graphitized carbon while supercapacitor electrode can be porous disordered carbon, active carbon, graphene, and/or titanium oxide.

In some implementations of the current subject matter, the current collector 340 can be a sheet (e.g., foil) or a three dimensional structure (e.g., foam, net) formed from one or more conductive materials including, for example, aluminum (Al), copper (Cu), nickel (Ni), titanium (Ti), carbon (e.g., graphene), and/or stainless steel.

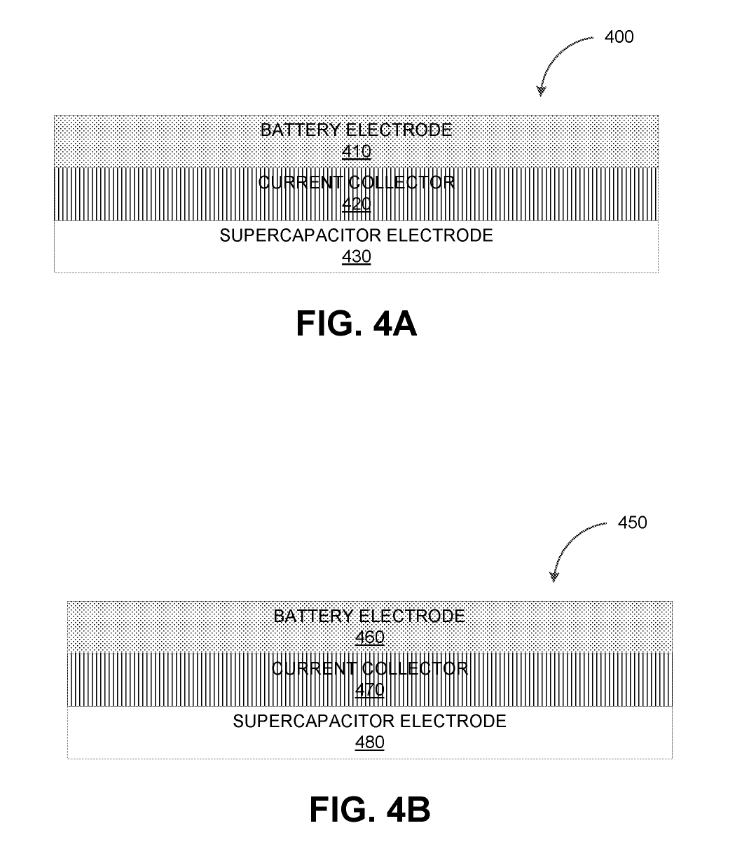

FIG. 4A depicts a schematic of a hybrid electrode 400 consistent with implementations of the current subject matter. Referring to FIG. 4A, the hybrid electrode 400 can include a battery electrode 410, a current collector 420, and a supercapacitor electrode 430. In some implementations of the current subject matter, the current collector 420 can be interposed between the battery electrode 410 and the supercapacitor electrode 430.

In some implementations of the current subject matter, the hybrid electrode 400 can be configured to act as a cathode of a battery and supercapacitor hybrid. As such, the battery electrode 410 can be formed from a lithium metal oxide including, for example, lithium nickel cobalt magnesium (NCM) oxide (LiNi_{1-x-y}CoₓMn_{y}O₂), lithium iron phosphate (LiFePO₄), and lithium manganese oxide (LiMn₂O₄). Alternately or additionally, the battery electrode 410 can be formed from lithium sulfur, lithium vanadium oxide, and/or titanium disulfide (TiS₂). The battery electrode 410 can further include one or more additives.

In some implementations of the current subject matter, the supercapacitor electrode 430 can be formed from activated carbon, graphene, carbon (C) nanostructures (e.g., tubes, wires, fibers), and/or metal oxides (e.g., titanium oxide (TiO₂)). The supercapacitor 430 can further include one or more types of additives.

In some implementations of the current subject matter, the current collector 420 can be a sheet (e.g., foil) formed from one or more conductive materials including, for example, aluminum (Al), copper (Cu), nickel (Ni), titanium (Ti), and/or stainless steel. Alternately, the current collector 420 can be three dimensional structure (e.g., foam, net) formed from one or more conductive materials including, for example, aluminum (Al), copper (Cu), nickel (Ni), titanium (Ti), carbon (e.g., graphene), and/or stainless steel. The current collector 420 can be porous in order to allow the diffusion of lithium ions from the battery electrode 410 to the supercapacitor electrode 430.

FIG. 4B depicts a schematic of a hybrid electrode 450 consistent with implementations of the current subject matter. Referring to FIG. 4B, the hybrid electrode 450 can include a battery electrode 460, a current collector 470, and a supercapacitor electrode 480. In some implementations of the current subject matter, the current collector 470 can be interposed between the battery electrode 460 and the supercapacitor electrode 480.

In some implementations of the current subject matter, the hybrid electrode 450 can be configured to act as an anode of a battery and supercapacitor hybrid. As such, the battery electrode 410 can be formed from, for example, graphite, carbon (e.g., soft or hard), micro bead carbon, and/or synthetic carbon. The electrode 460 can further include one or more additives.

In some implementations of the current subject matter, the supercapacitor electrode 480 can be formed from, for example, disordered carbon, carbon (C) nanostructures (e.g., tube, wire, fiber), and/or metal oxides (e.g., titanium oxide (TiO₂), tin oxide (SnO₂)). The supercapacitor electrode 480 can further include one or more types of additives.

In some implementations of the current subject matter, the current collector 470 can be a sheet (e.g., foil) formed from one or more conductive materials including, for example, aluminum (Al), copper (Cu), nickel (Ni), titanium (Ti), carbon (e.g., graphene), and/or stainless steel. Alternately, the current collector 420 can be a three dimensional structure (e.g., foam, net) formed from one or more conductive materials including, for example, aluminum (Al), copper (Cu), nickel (Ni), titanium (Ti), carbon (e.g., graphene), and/or stainless steel. In some implementations of the current subject matter, the current collector 470 can be porous to allow the diffusion of lithium ions from the electrode 460 to the supercapacitor 480.

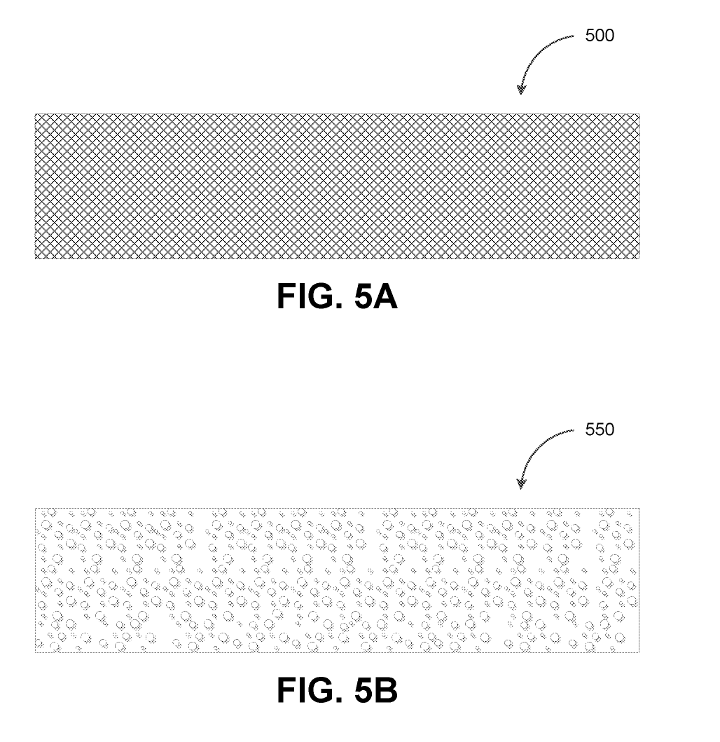

FIG. 5A depicts a three dimensional current collector 500 consistent with implementations of the current subject matter. Referring to FIGS. 1-5A, the three dimensional current collector 500 can implement the current collector 130, the current collector 220, the current collector 420, and/or the current collector 470.

In some implementations of the current subject matter, the three dimensional current collector 500 can be an expandable foil or foil net formed from one or more conductive materials. For example, the three dimensional current collector 500 can be formed from aluminum (Al), copper (Cu), copper (Cu) alloys, nickel (Ni), titanium (Ti), stainless steel, graphene, and/or carbon (C) nanostructures (e.g., tubes). The three dimensional current collector 500 can be porous, which allows the diffusion of lithium ions through the three dimensional current collector 500. Thus, lithium ions in a battery electrode (e.g., cathode) on one side of the three dimensional current collector 500 can diffuse through the three dimensional current collector 500 to a supercapacitor electrode (e.g., a negative electrode in a lithium ion supercapacitor) on the other side of the three dimensional current collector 500. The addition of the lithium ions to the supercapacitor can increase the capacitance of the supercapacitor and further enhance the power density of a battery and supercapacitor hybrid.

FIG. 5B depicts a three dimensional current collector 550 consistent with implementations of the current subject matter. Referring to FIGS. 1-4B and 5B, the three dimensional current collector 550 can implement the current collector 130, the current collector 220, the current collector 420, and/or the current collector 470.

In some implementations of the current subject matter, the three dimensional current collector 550 can be a foam formed from one or more conductive materials. For example, the three dimensional current collector 550 can be formed from aluminum (Al), copper (Cu), copper (Cu) alloys, nickel (Ni), titanium (Ti), stainless steel, graphene, and/or carbon (C) nanostructures (e.g., tubes). The three dimensional current collector 550 can be porous, which allows the diffusion of lithium ions through the three dimensional current collector 550. Thus, lithium ions in an electrode (e.g., cathode) on one side of the three dimensional current collector 550 can diffuse through the three dimensional current collector 550 to a supercapacitor electrode (e.g., a negative electrode in a lithium ion supercapacitor) on the other side of the three dimensional current collector 550. The addition of the lithium ions to the supercapacitor can increase the capacitance of the supercapacitor and further enhance the power density of a battery and supercapacitor hybrid.

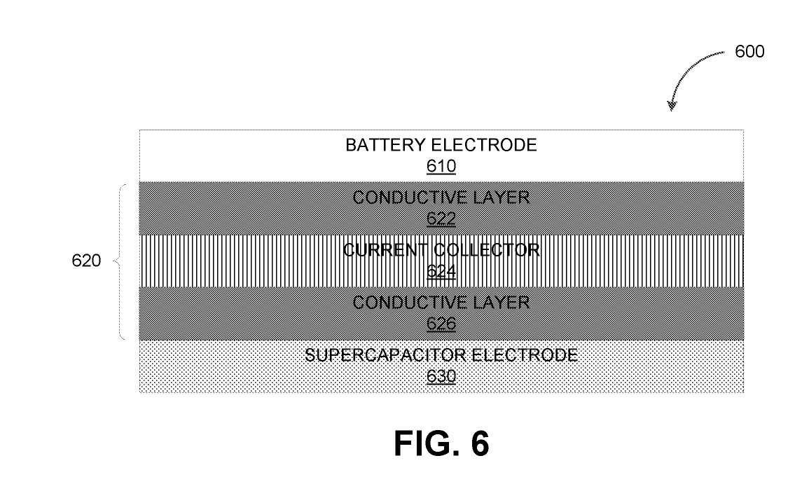

FIG. 6 depicts a schematic of a hybrid electrode 600 consistent with implementations of the current subject matter. Referring to FIG. 6, the hybrid electrode 600 can include a battery electrode 610, a composite current collector 620, and a supercapacitor electrode 630. As shown in FIG. 6, the composite current collector 620 can be interposed between the battery electrode 610 and the supercapacitor electrode 630.

In some implementations of the current subject matter, the composite current collector 620 can include a first conductive layer 622, a current collector 624, and a second conductive layer 626. The current collector 624 can be interposed between the first conductive layer 622 and the second conductive layer 626. The addition of the conductive layer can improve the cycle life of a battery and supercapacitor hybrid because the conductive layer enhances the adhesion of battery electrode 610 or the supercapacitor electrode 630 to the current collector 624.

In some implementations of the current subject matter, the first conductive layer 622 can be formed from a conductive metal while the second conductive layer 626 can be formed from a conductive polymer and/or a conductive composite. For instance, the conductive composite can include a polymer binder and one or more conductive additives. In one example configuration, the conductive additives can include nano-sized nickel (Ni) powder can be used at the cathode and nano-sized aluminum (Al) powder can be used at the anode. Alternately or additionally, the conductive additives can include one or more of carbon black, carbon (C) nanostructures (e.g., tubes), and graphene. It should be appreciated that the first conductive layer 622 can be formed from a conductive polymer and/or conductive composite while the second conductive layer 626 can be formed from a conductive metal without departing from the scope of the present disclosure.

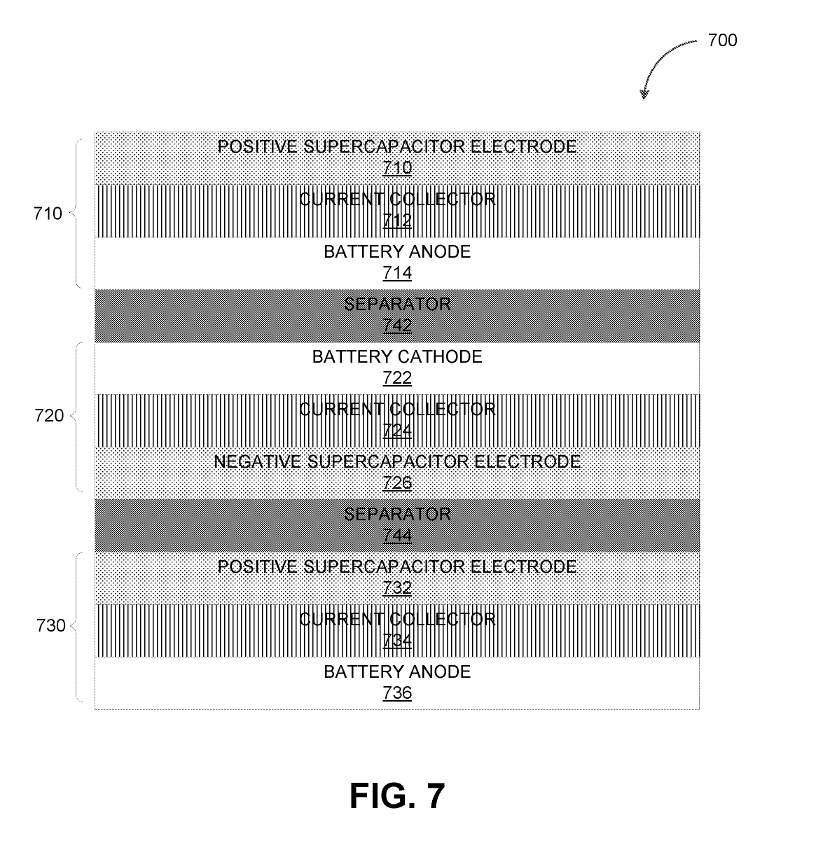

FIG. 7 depicts a schematic of an example of a battery and supercapacitor hybrid 700 consistent with implementations of the current subject matter. Referring to FIG. 7, the battery and supercapacitor hybrid 700 can include a plurality of hybrid electrodes including, for example, a first hybrid electrode 710, a second hybrid electrode 720, and a third hybrid electrode 730. The electrodes are disposed on opposite sides of separators. As shown in FIG. 7, the first hybrid electrode 710 is disposed on one side of a first separator 742 while the second hybrid electrode 720 is disposed on the other side of the first separator 742. Meanwhile, the second hybrid electrode 720 is disposed on one side of a second separator 744 while the third hybrid electrode 730 is disposed on the other side of the second separator 744.

In some implementations of the current subject matter, the hybrid electrodes on either sides of a separator can have opposite electrical polarities. Thus, as shown in FIG. 7, the first hybrid electrode 710 can be a positive electrode, the second hybrid electrode 720 can be a negative electrode, and the third hybrid electrode 730 can be a positive electrode. However, the first hybrid electrode 710, the second hybrid electrode 720, and the third hybrid electrode 730 can each have an opposite electrical polarity than shown without departing from the scope of the present disclosure.

As shown in FIG. 7, the first hybrid electrode 710 can be a positive electrode. As such, the first hybrid electrode 710 can include a first positive supercapacitor electrode 710, a first current collector 712, and a first battery anode 714. The first current collector 712 can be interposed between the first positive supercapacitor electrode 710 and the first battery anode 714. The second hybrid electrode 720 can be a negative electrode that includes a battery cathode 722, a second current collector 724, and a negative supercapacitor electrode 726. The second current collector 724 can be interposed between the battery cathode 722 and the negative supercapacitor electrode 726. Meanwhile, the third hybrid electrode 730 can also be a positive electrode. The third hybrid electrode 730 can include a second positive supercapacitor electrode 732, a third current collector 734, and a second battery anode 736. The third current collector 734 can be interposed between the second positive supercapacitor electrode 732 and the second battery anode 736.

In some implementations of the current subject matter, the battery and supercapacitor hybrid 700 can include at least one pair of hybrid electrodes. Thus, the battery and supercapacitor hybrid 700 can include fewer or more hybrid electrodes than shown in FIG. 7 without departing from the scope of the present disclosure. It should also be appreciated that the battery and supercapacitor hybrid 700 can include different and/or additional types of hybrid electrodes than shown in FIG. 7 (e.g., any one or more of the hybrid electrodes 100, 150, 200, 300, 400, 450, and 600) without departing from the scope of the present disclosure.

In some implementations of the current subject matter, the first separator 742 and/or the second separator 744 can include one or more electrolytes that allow for the movement of ions (e.g., lithium ions) between the first hybrid electrode 710 and the second hybrid electrode 720 and/or between the second hybrid electrode 720 and the third hybrid electrode 730. For example, the first separator 742 and/or the second separator 744 can include (e.g., moistened with) one or more electrolytes including, for example, a solid state electrolyte (e.g., L_{9.54}Si_{1.74}P_{1.44}S_{11.7}Cl_{0.3} and Li_{9.6}P₃S₁₂) and a mixture of lithium fluorophosphate (LiFP₆) in a carbonate solvent (e.g., ethyl carbonate (EC), dimethyl carbonate (DMC), diethyl carbonate (DEC)).

### Example of Battery and Supercapacitor Hybrids

### Example 1

A battery and supercapacitor hybrid with a disordered carbon negative electrode and a positive hybrid electrode. The supercapacitor electrode is disposed on top of the battery electrode in the positive hybrid electrode.

(A) Formulation: Table 1 lists the respective formulations for the battery anode, the positive supercapacitor electrode, and the negative electrode.

TABLE 1

| | | Percentage |
|---|---|---|
| Electrode ID | Component Materials | (%) |
| Battery Anode (first layer) | LiNi_{0.4}Mn_{0.3}Co_{0.3}O₂ (NMC433) | 92 |
| | Carbon black | 3 |
| | xGnP-R-10 (Graphene) | 1 |
| | PVDF (Polyvinylidene fluoride) | 4 |
| Positive Supercapacitor | YP-50F (Active carbon) | 87.5 |
| Electrode (second layer) | Carbon black | 2.5 |
| | TF-4000 (cross-linkable binder) | 5 |
| | PVDF | 5 |
| Negative Electrode | Disordered carbon | 92.7 |
| | Carbon black No. 1 | 2 |
| | xGnP-R-10 | 1 |
| | CMC (Carboxymethyle | 1.5 |
| | Cellulose) | |
| | SBR (Styrene-Butadiene | 2.8 |
| | Rubber) | |

(B) Electrode Preparation:

(a) Battery Anode (First Layer)

(i) Combine 48 grams (g) of polyvinylidene fluoride (PVDF) with 600 g of N-methyl-2-pyrrolidone (NMP). Stir the mixture at a rate of 1000 revolutions per minute (rpm) and store the mixture at the room temperature for 12 hours; (ii) Add 36 g of carbon black and 12 g of graphene xGnP-R-10 to the PVDF solution made in operation (i) and mix for 30 minutes at a rate of 5000 rpm; iii) Add 1104 g of NMC433 in the slurry and mix for 1.5 hour at a rate of 5000 rpm; iv) Add 1356 g of NMP to make a final slurry for the battery anode coating; and (v) Depositing the slurry onto 15 micrometers (μm) of aluminum (Al) foil with an automatic reverse-roll coating machine with a first oven set to 130° C. and a second oven set to 160° C. The resulting battery anode coating is approximately 12 milligrams per square centimeter (mg/cm²).

(b) Positive Supercapacitor Electrode (Second Layer)

(i) Combine 0.75 g of TF-4000 with 7.5 g of NMP and stir the mixture at a low rate for overnight; (ii) Combine 0.75 g of PVDF with 10 g of NMP and mix at a rate of 1000 rpm until the PVDF is dissolved into the NMP; (iii) Combine the solutions prepared in operations (i) and (ii) with 0.8 g of carbon black and mix for 30 minutes at a rate of 5000 rpm; (iv) Add 13.125 g of active carbon YP-50F into the slurry and mix at a rate of 5000 rpm for 60 minutes; and (v) Coat the slurry onto the surface of battery positive electrode (the first layer) with automatic reverse-roll coating machine with the first oven set to 130° C. and the second oven set to 160° C. to dry out the NMP. The resulting solid coating of battery anode and positive supercapacitor electrode is approximately 15 mg/cm².

(c) Negative Electrode

(i) Add 150 g of DI water into 9 g of CMC and mix at a low rate and store at room temperature overnight; (ii) Add 12 g of carbon black and 6 g of xGnP-R-10 To the slurry created in operation (i) and mix for 30 minutes at a rate of 5000 rpm; iii) Add 556.2 g of petroleum Coke or disordered carbon and mixing for one hour at a rate of 5000 rpm; iv) Add a suitable amount of DI water to adjust the slurry to form a slurry having an appropriate viscosity for coating; (v) Adding 16.8 g of SBR to the slurry created at operation (iv) and mix for 30 minutes at a rate of 500 rpm; and (vi) Coat the slurry onto 8 μm of copper (Cu) foil with automatic reverse-roll coating machine with the first oven and/or second oven set to 110° C. The resulting solid negative electrode coating is about 7 mg/cm².

(C) Battery Cell Assembly: (i) Compress the positive hybrid electrode and the negative electrode to achieve a target thickness and cut resulting film into a portion that is approximately 4.5 cm wide and 5.5 cm high; (ii) Laminate the compressed portion of the positive hybrid and negative electrode with a 40 □m thick separator to form a jelly flat; (iii) Place the jelly flat into a receptacle (e.g., bag) and dry at 70° C. for 16 hours; (iv) Moisten the dried separator from operation (iii) with a sufficient amount of 1.2 molarity LiPF₆ ethylene carbonate based electrolyte, and store room temperature for at least 12 hours; and (v) Charge the battery at a low current for at least five hours and grade the cell for the testing. Charge the battery at 2.5 A to 3.8V and discharge the battery to 2.2V at 1 A, 2 A, 3 A and 5 A, respectively.

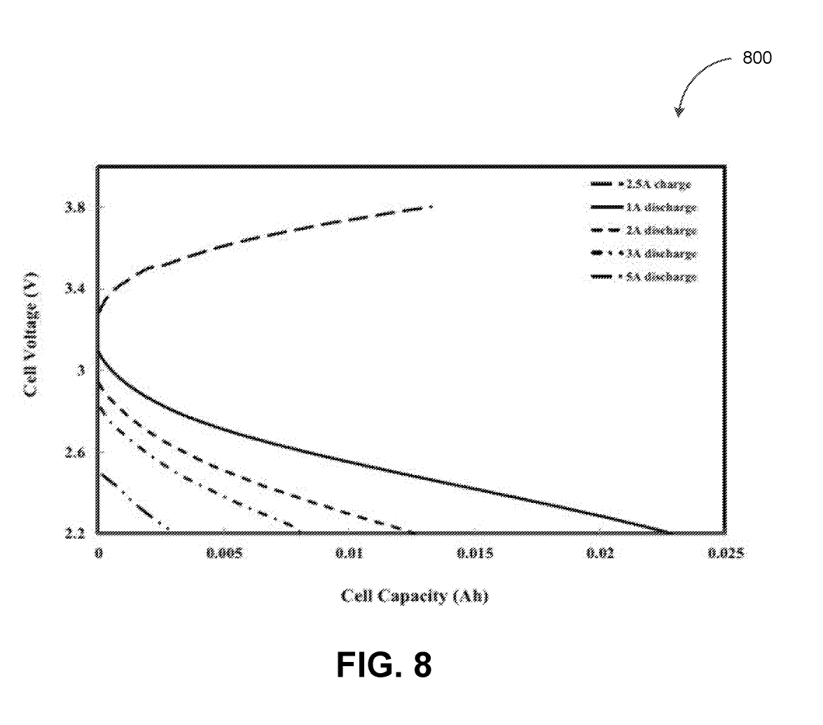

FIG. 8 depicts a graph 800 illustrating the relationship between battery capacity and battery voltage at different charging and discharging currents. For instance, graph 800 shows the capacity curve of a battery (e.g., in ampere hours (Ah)) that is charged at 2.5 amperes (A) to 3.8 volts (V). Graph 800 further shows the capacity curves of the battery when it is discharged to 2.2 V at discharging currents of 1 A, 2 A, 3 A, and 5 A. The charge and discharge of the battery is performed at room temperature. The testing procedure includes: i) rest for 5 minutes; ii) charge to 3.8V at 2.5 A; iii) rest for 10 minutes; iv) discharge to 2.2V at 1 A; v) rest for ten minutes; vi) charge to 3.8V at 2.5V; vii) rest for 10 minutes; viii) discharge to 2.2V at 2 A; ix) rest for ten minutes; x) charge to 3.8V at 2.5V; xi) rest for 10 minutes; xii) discharge to 2.2V at 3 A; xiii) rest for ten minutes; xiv) charge to 3.8V at 2.5V; xv) rest for 10 minutes; xvi) discharge to 2.2V at 2 A; and xvii) rest for ten minutes.

### Example No. 2

A battery and supercapacitor hybrid with a disordered carbon negative electrode and a battery anode disposed on the top of a safety layer:

(A) Formulation: Table 2 lists the respective formulations the battery anode, the safety layer, and the negative electrode.

TABLE 2

| Electrode | Component Materials | Percentage (%) |
|---|---|---|
| Safety Layer | CaCO₃ (Calcium carbonate) | 80.2 |
| (first layer) | Carbon black | 5.8 |
| | TF-4000 (cross-linkable binder) | 2 |
| | PVDF | 12 |
| Battery Anode | NMC433 | 92 |
| (second layer) | Carbon black | 3 |
| | xGnP-R-10 (Graphene) | 1 |
| | PVDF-A | 4 |
| Negative | Coke | 92.7 |
| Electrode | Super-P | 2 |
| | xGnP-R-10 | 1 |
| | CMC | 1.5 |
| | SBR | 2.8 |

(B) Preparation:

(a) Safety Layer (First Layer)

(i) Dissolve 2 g of TF-4000 into 20 g of NMP and stir at a low rate for at least 12 hours; ii) Dissolve 12 g of PVDF into 150 g of NMP, mix, and store for at least 12 hours; (iii) Add 5.8 g of carbon black into the solution prepared in operation (ii) and mix for 30 minutes at a rate of 5000 rpm; iv) Add 80.2 g of CaCO₃ to the slurry prepared in operation (iii) and mix for 1.5 hour at a rate of 5000 rpm; v) Add 281 g of NMP to the slurry prepared in operation (iv); and (vi) Coat the slurry onto 15 □m Al foil with an automatic reverse-roll coating machine and a first oven set to 130° C. and a second oven set to 160° C. The resulting solid coating is approximately 0.7 mg/cm².

(b) Battery Anode (Second Layer)

(i) Dissolve 20 g of PVDF into 250 g of NMP; (ii) Add 15 g of carbon black and 5 g of graphene xGnP-10-R into the PVDF-NMP solution and mix for 30 minutes at a rate of 5000 rpm; (iii) Add 460 g of NMC433 into the slurry prepared in operation (ii) and mix at a rate of 5000 rpm for 60 minutes; and (iv) Coating the slurry onto the surface of the safety layer (or another layer) with an automatic reverse-roll coating machine and with the first oven set to 130° C. and the second oven to 160° C. to dry out the NMP. The resulting solid coating is approximately 0.7+12 mg/cm2.

(c) Negative Electrode: See preparations of the negative electrode in Example No. 1.

(C) Battery Cell Assembly: (i) Compress the battery anode and the safety layer to achieve a target thickness and cut the resulting film into a portion that is approximately 4.5 cm wide and 5.5 cm high; (ii) Laminate the compressed portion of the safety layer and battery anode with a 20 μm thick separator to form a jelly flat; (iii) Place the jelly flat into a receptacle (e.g., bag) and dry at 70° C. for 16 hours; (iv) Moisten the dried separator from operation (iii) with a sufficient amount of 1.2 molarity LiPF₆ ethylene carbonate based electrolyte, and store room temperature for at least 12 hours; and (v) Charge the battery at a low current for at least five hours and grade the cell for testing. The capacity of the battery is approximately 0.33 Ah.

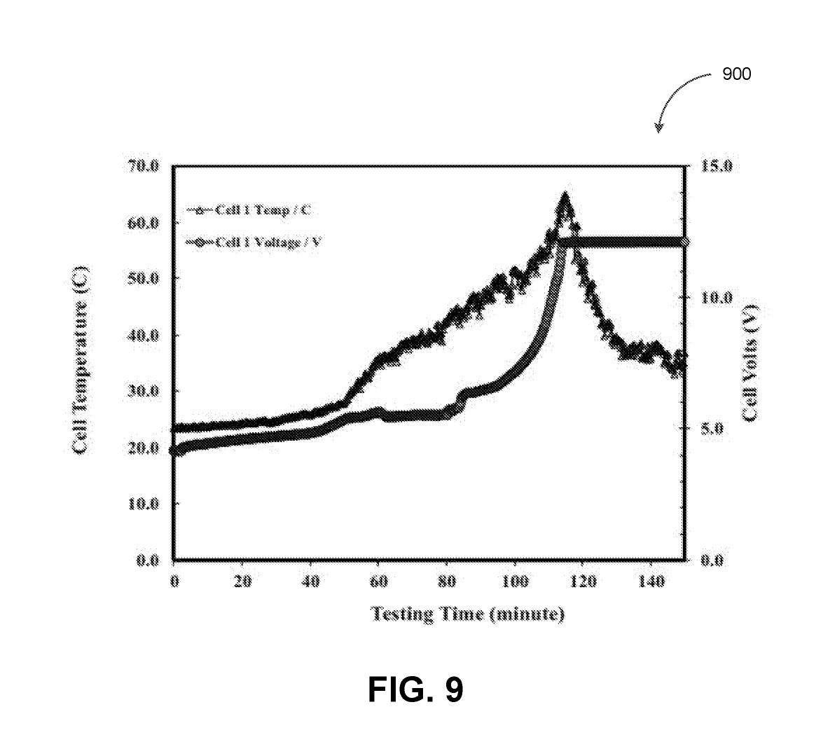

FIG. 9 depicts a graph 900 illustrating the voltage profile and temperature profile of a battery as the battery is overcharged over a period of time. The fully charged battery was placed into a chamber and then charged to 12V at 0.6 A by a power supplier (300 W) until the maximum temperature of the battery decreased to around the room temperature. The temperature and voltage of the battery were measured and recorded during the test. The presence of the safety layer ensures that the temperature and voltage of the battery does not exceed hazardous levels. As shown in FIG. 9, the safety layer operates to limit the temperature and/or voltage of the battery in overcharge scenarios.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations can be within the scope of the following claim.

What is claimed is:

1. A battery and supercapacitor hybrid, comprising:
a first hybrid electrode comprising a first battery electrode, a first current collector, and a first supercapacitor electrode;
a second hybrid electrode; and
a separator interposed between the first hybrid electrode and the second hybrid electrode.

2. The battery and supercapacitor hybrid of claim 1, wherein the first battery electrode is disposed on one side of the first current collector, and wherein the first supercapacitor electrode is disposed on a different side of the first current collector.

3. The battery and supercapacitor hybrid of claim 1, wherein the first battery electrode is interposed between the first current collector and the first supercapacitor electrode.

4. The battery and supercapacitor hybrid of claim 1, wherein the first supercapacitor electrode is interposed between the first battery electrode and the first current collector.

5. The battery and supercapacitor hybrid of claim 1, wherein the first hybrid electrode further comprises a safety layer interposed between the first electrode and the first current collector.

6. The battery and supercapacitor hybrid of claim 5, wherein the safety layer is formed from a material that exhibits an increasing electrical resistance in response to an increase in temperature, voltage, and/or current.

7. The battery and supercapacitor hybrid of claim 5, wherein the safety layer is formed from a material that includes a thermal activated additive, a voltage activated additive, and/or a current activated additive.

8. The battery and supercapacitor hybrid of claim 5, wherein the safety layer is formed from a material that includes at least one cross-linkable binder.

9. The battery and supercapacitor hybrid of claim 5, wherein the safety layer is formed from a material that decomposes to generate a gas in response to a temperature, voltage, and/or current trigger, and wherein the generating of the gas electrically decouples the first electrode from the first current collector at least by forming a nonconductive gap between the first electrode and the first current collector.

10. The battery and supercapacitor hybrid of claim 1, wherein the first hybrid electrode comprises a cathode of the battery and supercapacitor hybrid.

11. The battery and supercapacitor hybrid of claim 10, wherein the first electrode is formed from a lithium metal oxide, and wherein the first supercapacitor electrode is formed from a mixture of active carbon and/or graphene combined with one or more additives.

12. The battery and supercapacitor hybrid of claim 1, wherein the first hybrid electrode comprises an anode of the battery and supercapacitor hybrid.

13. The battery and supercapacitor hybrid of claim 12, wherein the first electrode is formed from porous disordered carbon and/or graphitized carbon, and wherein the supercapacitor electrode is formed from disordered carbon and/or lithium titanate spinel.

14. The battery and supercapacitor hybrid of claim 1, wherein the second hybrid electrode comprises a second battery electrode, a second current collector, and a second supercapacitor electrode.

15. The battery and supercapacitor hybrid of claim 1, wherein the first current collector is formed from a sheet or a foil of conductive material.

16. The battery and supercapacitor hybrid of claim 1, wherein the first current collector is formed from a foam or a net of conductive material.

17. The battery and supercapacitor hybrid of claim 13, wherein the first current collector is formed from a porous material that permits a diffusion of lithium ions from the first electrode to the first supercapacitor electrode.

18. The battery and supercapacitor hybrid of claim 1, wherein the first current collector is formed from one or more of aluminum (Al), copper (Cu), copper (Cu) alloys, nickel (Ni), titanium (Ti), stainless steel, graphene, and carbon (C) nanostructures.

19. The battery and supercapacitor hybrid of claim 1, further comprising at least one composite current collector that includes the first current collector interposed between a first conductive layer and a second conductive layer.

20. The battery and supercapacitor hybrid of claim 16, wherein the first conductive layer and/or the second conductive layer are formed from a conductive polymer and/or a conductive composite.

21. The battery and supercapacitor hybrid of claim 1, wherein the separator includes one or more electrolytes.

22. The battery and supercapacitor hybrid of claim 17, wherein the one or more electrolytes include a solid state electrolyte, and/or a liquid electrolyte in an ethyl carbonate (EC), dimethyl carbonate (DMC), and/or diethyl carbonate (DEC) solvent.

23. The battery and supercapacitor hybrid of claim 1, wherein the first supercapacitor is formed from a material that includes at least one cross-linkable binder.
